(19) United States
(12) Patent Application Publication
(10) Pub. No.: US 2009/0115753 A1
(43) Pub. Date: May 7, 2009

(54) DISPLAY APPARATUS AND CONTROLLING METHOD THEREOF

(76) Inventor: Hsin-Hsun CHEN, Sinjhuang City (TW)

Correspondence Address: Muncy, Geissler, Olds & Lowe, PLLC, P.O. BOX 1364, FAIRFAX, VA, 22038-1364, US

(21) Appl. No.: 12/261,634

(22) Filed: Oct. 30, 2008

(30) Foreign Application Priority Data
Nov. 6, 2007 (TW) 096141794

(51) Int. Cl. G06F 3/038

(52) U.S. Cl. 345/204

(57) ABSTRACT

A display apparatus is provided. The display apparatus includes a first video signal input terminal, a second video signal input terminal, a multiplexer, an identification detector, and a controller. The multiplexer has an identification output terminal, a first identification input terminal, and a second identification input terminal. The first identification input terminal is used for receiving a first identification code corresponding to the first video signal input terminal; the second identification input terminal is used for receiving a second identification code corresponding to the second video signal input terminal. When the identification detector detects either the first identification code or the second identification code is outputted from the identification output terminal, the controller forbids the multiplexer from being switched between the identification input terminals.

### BACKGROUND OF THE INVENTION

1. Field of the Invention

The invention relates to a display apparatus and, more particularly, to a controlling method for ensuring an identification code of the display apparatus being completely read.

2. Description of the Prior Art

Digital Visual Interface (DVI) is a visual interface standard which is getting more and more popular. In addition to pins for transmitting video data, the DVI connector also includes pins for transmitting Extended Display Identification Data (EDID). In general, EDID is recorded in the memory inside the display (such as a liquid crystal display). Information of the display, such as the model number, type of luminous body, resolution, screen scale, and so on, can be obtained from the EDID. After reading the EDID of the display, the display card must correspondingly adjust the video data provided for the display. If the EDID of the display cannot be read, some display cards will not even transmit video data to the display.

According to the property of transmitted signals, the DVI connector can be one of following three types: DVI-A, DVI-D, and DVI-I. The DVI-A connector is used for transmitting analog signals. The DVI-D connector is used for transmitting digital signals. And the DVI-I connector is capable of transmitting both analog and digital signals. Therefore, if a display with DVI-I connector has the capability of processing both digital and analog signals, the display will therein store two EDIDs respectively corresponding to digital and analog signals.

Please refer to FIG. 1, which illustrates the pins of a DVI-I connector. The pins of number 8 and C1˜C5 are used for transmitting analog signals. The pin of number 6 is used for transmitting the Display Data Channel (DDC) clock. The pin of number 7 is used for transmitting a DDC data. The pins of number 14 and 15 are power-supplying pins, and the other pins are used for transmitting digital signals.

FIG. 2 is a schematic diagram illustrating the connection between a display card and a display. As shown in FIG. 2, the display card 100 and the display 200 are coupled to each other via a DVI-I connector 210. The analog signal line VA is connected to the pins for transmitting analog signals of DVI-I connector 210. The digital signal line VD is connected to the pins for transmitting digital signals of DVI-I connector 210. Furthermore, the signal line DDC_C is connected to the DDC clock pin (pin 6 in FIG. 1) in the DVI-I connector 210, and the signal line DDC_D is connected to the DDC data pin (pin 7 in FIG. 1) in the DVI-I connector 210.

In this example, the first memory section 220A therein stores the EDID corresponding to the digital signal of display 200; the second memory section 220B therein stores the EDID corresponding to the analog signal of display 200. Because the digital and analog EDIDs are transmitted to the display card 100 via the same set of signal lines (DDC_C and DDC_D), it is necessary to set a multiplexer 230A between the DVI-I connector 210 and the memories for storing the analog/digital EDIDs.

When the output terminal of multiplexer 230A is switched to be connected with the signal lines of first memory section 220A (SDA_1 and SCL_1), the display card 100 can read the digital EDID stored in the first memory section 220A via the DVI-I connector 210 and the multiplexer 230A. In the same manner, when the output terminal of multiplexer 230A is switched to be connected with the signal lines of second memory section 220B (SDA_2 and SCL_2), the display card 100 can read the analog EDID stored in second memory section 220B via the DVI-I connector 210 and the multiplexer 230A.

As shown in FIG. 2, the signal lines VA and VD are connected to the video processing module 240 via another multiplexer 230B. The video processing module 240 can choose to receive/process digital or analog video signals via switching the multiplexer 230B and then transmit the processed signal to the display module 260 for displaying. When the display 200 does not receive the external signals, the controlling module 270 periodically switches the input terminal of multiplexer 230B between the signal lines VA and VD. Then the video signal detecting module 250 detects whether the output terminal VI of multiplexer 230B receives any signal. If the video signal detecting module 250 detects video signals on the output terminal VI, the controlling module 270 stops switching periodically. In other words, once the video signal detecting module 250 detects that certain input terminal starts to receive video signals, the controlling module 270 controls the output terminal VI of multiplexer 230B to be fixedly connected to the input terminal that receives video signals.

In general, the controlling module 270 switches multiplexers 230A and 230B synchronously. Specifically, when the output terminal VI of multiplexer 230B is switched to be connected with the video signal line VD, the output terminals of multiplexer 230A are also switched to be connected with the first memory section 220A therein stores the digital EDID. In the same manner, when the output terminal VI of multiplexer 230B is switched to be connected with the analog signal line VA, the output terminals of multiplexer 230A are switched to be connected with the second memory section 220B therein stores the analog EDID.

As described above, before completely reading the EDID of display 200, some display cards do not transmit video signals to the display 200. In the example shown in FIG. 2, the signal line VD is corresponding to the digital EDID stored in the first memory section 220A. Only after reading the digital EDID completely, the display card 100 starts to transmit digital video signals to the display 200 via the signal line VD.

The video signal detecting module 250 in prior arts does not consider the condition when the display card 100 is reading the EDID. Specifically, when the display card 100 is reading the EDID, the video signal detecting module 250 could be detecting whether the output terminal VI of multiplexer 230B is receiving any signal or not at the same time. Assuming the display card 100 is reading the digital EDID stored in the first memory section 220A, if the video signal detecting module 250 and the controlling module 270 switches the input terminals of multiplexer 230A from SDA_1/SCL_1 to SDA_2/SCL_2 at this time, then the procedure that the display card 100 reads the digital EDID will be interrupted. The display card 100 accordingly cannot read the digital EDID completely.

This error in reading could make the display card 100 unable to output digital video data with high quality. Even if the display 200 is capable of displaying video data with high quality, the display 200 might be unable to output the high quality data or even outputs nothing just because the EDID was not successfully read.

### SUMMARY OF THE INVENTION

In order to solve the aforesaid problems, a scope of the invention is to provide a display apparatus and a controlling method thereof. In the display apparatus according to the invention, when the multiplexer is outputting an EDID, a controlling module forbids the multiplexer from being switched between different input terminals, so as to prevent the identification code of the display apparatus from being read incompletely.

One embodiment according to the invention is a display apparatus including a first video signal input terminal, a second video signal input terminal, a multiplexer, an identification detector, and a controlling module. The multiplexer has an identification output terminal, a first identification input terminal, and a second identification input terminal. The first identification input terminal is used for receiving a first identification code corresponding to the first video signal input terminal; the second identification input terminal is used for receiving a second identification code corresponding to the second video signal input terminal. When the identification detector detects that the identification output terminal is outputting the first or the second identification code, the controlling module forbids the multiplexer from being switched between the identification input terminals.

The advantage and spirit of the invention may be understood by the following recitations together with the appended drawings.

### BRIEF DESCRIPTION OF THE APPENDED DRAWINGS

FIG. 1 is the pinout of the DVI-I connector.

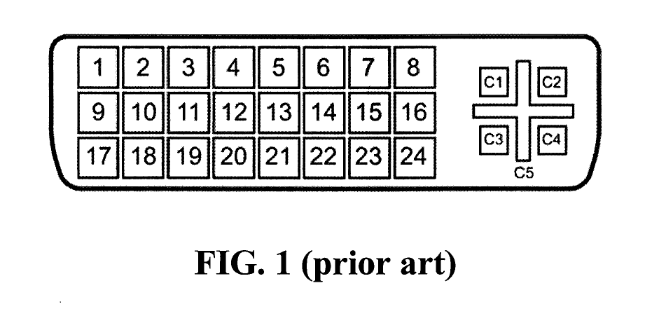

FIG. 2 is a schematic diagram illustrating the connection between the display card and the display.

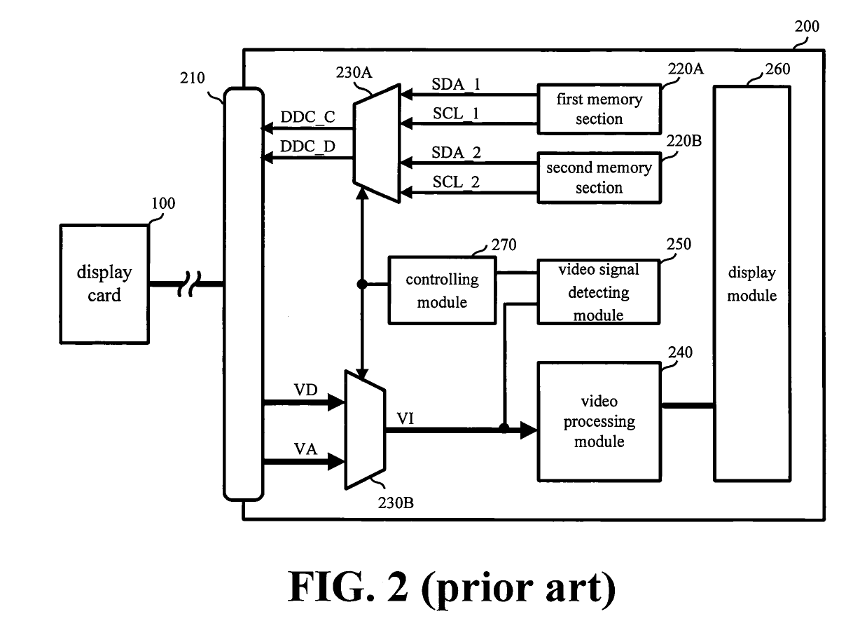

FIG. 3 is a functional block diagram illustrating a display apparatus according to the invention.

FIG. 4 is an exemplary waveform of an EDID data line and a clock line.

FIG. 5 and FIG. 6 are flow charts showing a method for controlling the display apparatus according to the invention.

### DETAILED DESCRIPTION OF THE INVENTION

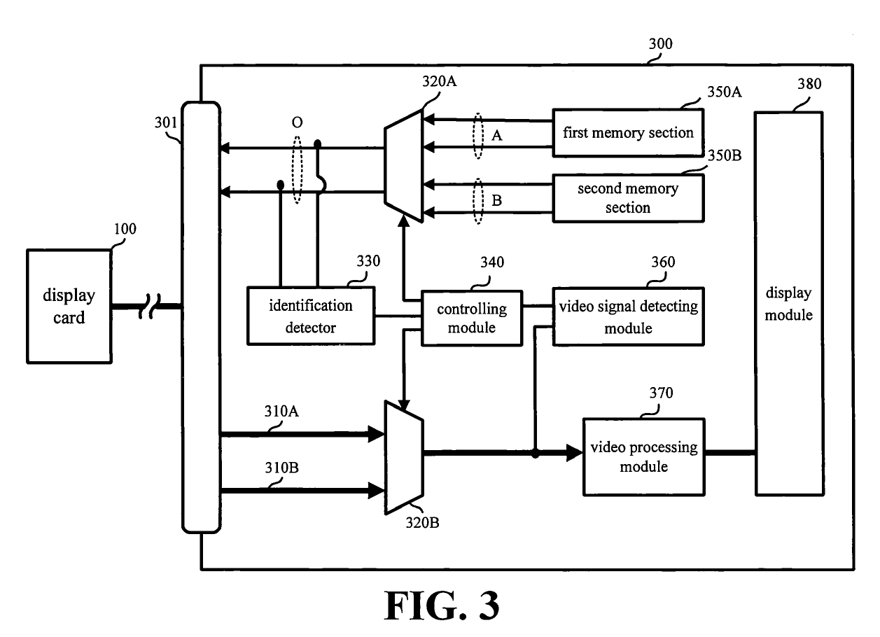

Please refer to FIG. 3, which illustrates a functional block diagram of a display apparatus 300 according to an embodiment of the invention. The display apparatus 300 is connected to a display card 100 via a connector 301 and includes a first video signal input terminal 310A, a second video signal input terminal 310B, a multiplexer 320B, a multiplexer 320A, a video signal detecting module 360, an identification detector 330, and a controlling module 340. In addition, the display apparatus 300 includes a first memory section 350A therein stores a first identification code and a second memory section 350B therein stores a second identification code.

The first identification code is corresponding to the first video signal input terminal 310A, and the second identification code is corresponding to the second video signal input terminal 310B. In actual applications, the first identification code and the second identification code can respectively include a set of EDID. For example, the first video signal input terminal 310A is used for receiving the digital video signal, and the first identification code includes the digital video EDID needed when the display apparatus 300 displays the digital video signal. The second video signal input terminal 310B is used for receiving the analog video signal, and the second identification code includes the analog video EDID needed when the display apparatus 300 displays the analog video.

As shown in FIG. 3, the multiplexer 320A has an identification output terminal O, a first identification input terminal A, and a second identification input terminal B. Wherein the first identification input terminal A is used for receiving the first identification code, and the second identification input terminal B is used for receiving the second identification code.

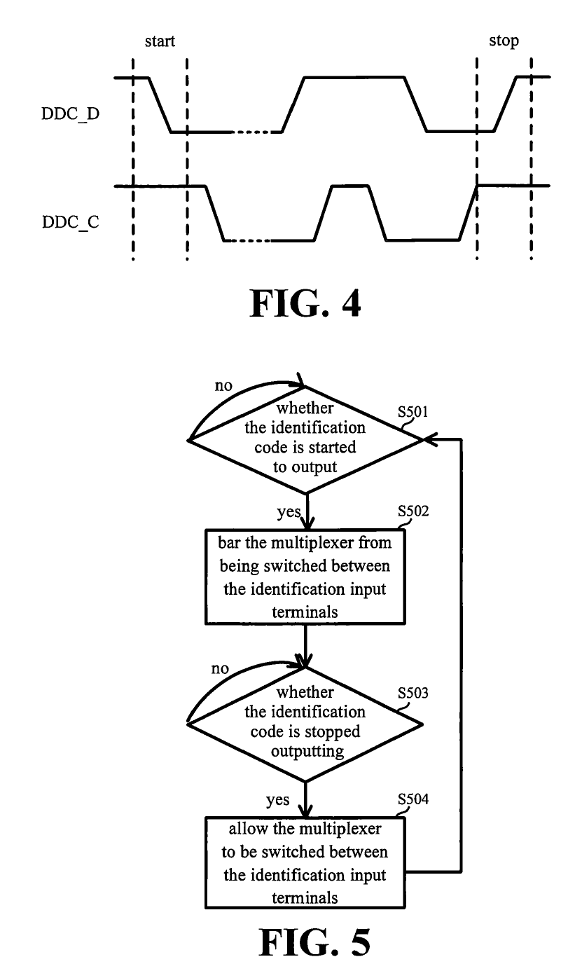

The identification detector 330 is used for detecting the output state of identification output terminal O. Taking the practical condition that the identification codes include EDIDs for example, the identification output terminal O includes a data line DDC_D and a clock line DDC_C. Please refer to FIG. 4, which illustrates exemplary waveforms of the two signal lines. As shown in FIG. 4, when the voltage of DDC_C signal is at high level, a falling edge in the DDC_D signal represents that the identification output terminal O is starting to output an EDID identification code. On the other side, when the voltage of DDC_C signal is at high level, a rising edge in the DDC_D signal represents that the identification output terminal O is stopping outputting the EDID identification code.

In addition, as shown in FIG. 3, the first video signal input terminal 310A and the second video signal input terminal 310B are connected to a video processing module 370 via a multiplexer 320B. The video processing module 370 can choose to receive/process the digital or analog video signal by switching the multiplexer 320B and can transmit the processed signal to the display module 380 for displaying. In actual applications, the display module 300 can further include a video signal detecting module 360 used for detecting the output terminal of multiplexer 320B.

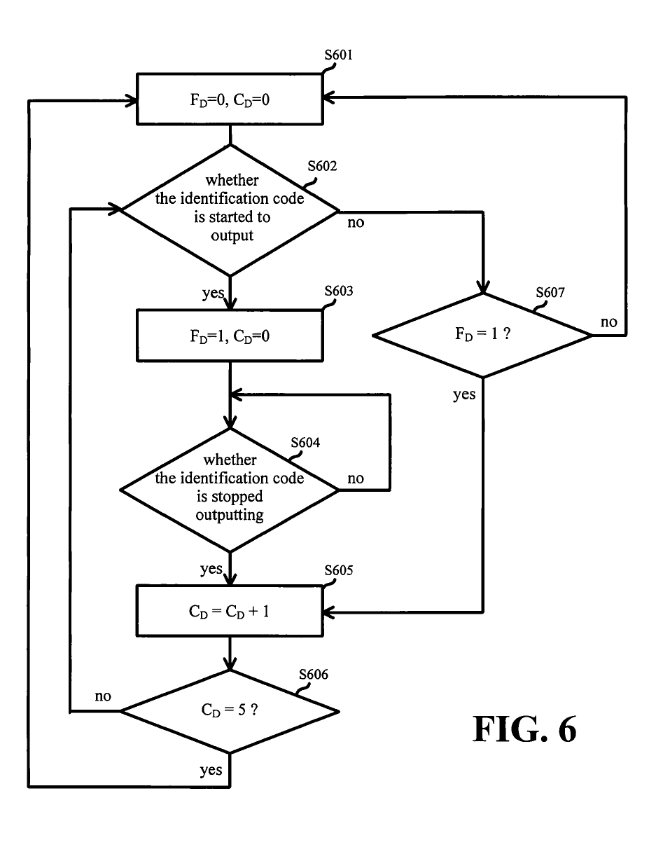

Please refer to FIG. 5, which illustrates an operation flow chart of identification detector 330 and controlling module 340. As shown in step S501, first of all, the identification detector 330 continuously detects the output state of the identification output terminal O and judges whether the identification output terminal O starts to output the identification code. If the result of step S501 is yes, the identification detector 330 will perform step S502 and make the controlling module 340 forbid the multiplexer 320A from being switched between the first identification input terminal A and the second identification input terminal B.

Further, as shown in step S503, the identification detector 330 will continue detecting the output state of the identification terminal O and judge whether the output identification terminal O stops outputting the identification code. If the result of step S503 is yes, the identification detector 330 can judge that certain EDID identification code has been read completely. Then in step S504, the controlling module 340 rehabilitates the switching function of the multiplexer 320A.

In other words, when the output state shows the identification output terminal O does not output the first identification code or the second identification code, the controlling module 340 allows the multiplexer 320A to be switched between the first identification input terminal A and the second identification input terminal B.

In addition, in step S502, other than the multiplexer 320A from being switched to the identification input terminal, the controlling module 340 can choose (1) to forbid the multiplexer 320B from being switched between the input terminal 310A, 310B and the output terminal of multiplexer 320B, or (2) to allow the multiplexer 320B to keep periodically being switched.

In actual applications, step S504 can also be delayed until a specific time after the controlling module 340 stops outputting the identification code from the identification output terminal O. In other words, after the specific duration, step S504 is performed to control the multiplexer 320A to be switched periodically again. In another embodiment, the controlling module 340 can further confirm whether the identification output terminal O restarts to output the identification code during the duration. Only if the identification detector 330 does not detect that the identification output terminal O starts to output the identification code again, the controlling module 340 performs step S504 to control the multiplexer 320A to be switched between the first identification input terminal A and the second identification input terminal B.

On the other hand, when the controlling module 340 controls the input terminal of multiplexer 320A to be switched, the multiplexer 320B can also be switched at the same time. For this reason, the video signal detecting module 360 can detect whether the first video signal input terminal 310A or the second video signal input terminal 310B receives any video signal.

Therefore, when (1) the identification detector 330 detects the identification output terminal O does not output any identification code, and (2) the video signal detecting module 360 is going to detect whether the first video signal input terminal 310A receives any video signal, the controlling module 340 controls the multiplexer 320B to be switched to the first video signal input terminal 310A. Correspondingly, the multiplexer 320A is switched to the first identification input terminal A. The first identification code (such as a digital video EDID) can accordingly be transmitted to the display card 100, and the video signal detecting module 360 can detect whether the display card 100 outputs the first video signal (such as the digital video signal).

When (1) the identification detector 330 detects the identification output terminal O does not output any identification code, and (2) the video signal detecting module 360 is going to detect whether the second video signal input terminal 310B receives any video signal, the controlling module 340 controls the multiplexer 320B to be switched to the second video signal input terminal 310B. Correspondingly the multiplexer 320A is switched to the second identification input terminal B. The second identification code (such as an analog video EDID) can accordingly be transmitted to the display card 100, and the video signal detecting module 360 can detect whether the display card 100 outputs the second video signal (such as the analog video signal).

In embodiments according to the invention, the purpose of controlling the switching function of the multiplexer 320A can be implemented with a counter and a flag. Please refer to FIG. 6, which illustrates an exemplary flowchart utilizing this idea.

In this example, first of all, as shown in step S601, a flag F_{D} and a counted number C_{D} of a counter are both set as 0. Step S602 is performed to judge whether the output terminal O of multiplexer 320A starts to output identification codes. If the judging result of step S602 is yes, the flag F_{D} is set as 1 in step S603 and the counted number C_{D} is maintained as 0.

Further, step S604 is performed to judge whether the output terminal O of multiplexer 320A stops outputting the identification code. If the judging result of step S604 is no, step S604 is performed repeatedly. If the judging result of step S604 is yes, the counted number C_{D} is added with 1 in step S605. And further step S606 is performed to judge whether the counted number C_{D} reaches some default value (for instance, 5). If the judging result of step S606 is yes, step S601 is performed again. On the contrary, if the judging result of step S606 is no, step S602 is performed again.

In addition, if the judging result of step S602 is no, step S607 is performed to check whether the state of F_{D} is 1. If the judging result of step S607 is yes, step S605 and the following steps are performed. If the judging result of step S607 is no, step S601 is performed again.

When the identification output terminal O starts to output an identification code, another flag F_{D} is set as 1. After the identification output terminal O stops outputting the identification code, the counter starts to check the identification output terminal O at specific intervals (for example, every 20 ms). If the identification detector 330 does not detect that the identification output terminal starts to output the identification code after repeated checks, the flag F_{D} is set as 0. When the flag F_{D} is 1, the switching function of the multiplexer 320A is stopped. When the flag F_{D} is 0, the multiplexer 320A is allowed to be switched.

As described above, when the multiplexer is outputting the identification code, the controlling module and method according to the invention can forbid the multiplexer from being switched between different input terminals, so as to prevent the condition that the identification code of a display apparatus cannot be completely read.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A display apparatus, comprising:
a first video signal input terminal;
a second video signal input terminal;
a multiplexer with an identification output terminal, a first identification input terminal, and a second identification input terminal, the first identification input terminal being used for receiving a first identification code corresponding to the first video signal input terminal, the second identification input terminal being used for receiving a second identification code corresponding to the second video signal input terminal;
an identification detector, electrically coupled to the multiplexer, for detecting an output state of the identification output terminal; and
a controlling module, electrically coupled to the identification detector and the multiplexer, when the output state shows that the first identification code or the second identification code is being outputted from the identification output terminal, the controlling module controlling the multiplexer stopping switching between the first identification input terminal and the second identification input terminal.

2. The display apparatus of claim 1, wherein the first identification code and the second identification code respectively comprises a set of extended display identification data (EDID).

3. The display apparatus of claim 1, wherein when the output state shows that the first identification code or the second identification code is not being outputted from the identification output terminal, the controlling module enables the multiplexer to be switched between the first identification input terminal and the second identification input terminal.

4. The display apparatus of claim 1, wherein when the output state shows that the identification output terminal stops outputting the first identification code or the second identification code, the controlling module makes the multiplexer to be switched between the first identification input terminal and the second identification input terminal after a confirming duration.

5. The display apparatus of claim 1, wherein if the output state shows that the identification output terminal does not output the first identification code or the second identification code again in a confirming duration after the identification output terminal stops outputting the first identification code or the second identification code, the controlling module makes the multiplexer to be switched between the first identification input terminal and the second identification input terminal.

6. The display apparatus of claim 1, further comprising a video signal detecting module, when the controlling module makes the multiplexer to be switched between the first identification input terminal and the second identification input terminal, the controlling module controlling the video signal detecting module to alternately detect whether the first video signal input terminal or the second video signal input terminal receives any video signal.

7. The apparatus of claim 6, wherein when the video signal detecting module is detecting whether the first video signal input terminal receives any video signal, the controlling module makes the multiplexer to be switched to the first identification input terminal; when the video signal detecting module is detecting whether the second video signal input terminal receives any video signal, the controlling module controls the multiplexer to be switched to the second identification input terminal.

8. A controlling method for a display apparatus, the display apparatus comprising a first video signal input terminal, a second video signal input terminal, and a multiplexer, the multiplexer having an identification output terminal, a first identification input terminal, and a second identification input terminal, the first identification input terminal being used for receiving a first identification code corresponding to the first video signal input terminal, the second identification input terminal being used for receiving a second identification code corresponding to the second video signal input terminal, the controlling method comprising the steps of:
detecting an output state of the identification output terminal; and
when the output state shows that the first identification code or the second identification code is being outputted from the identification output terminal, controlling the multiplexer stopping switching between the first identification input terminal and the second identification input terminal.

9. The controlling method of claim 8, wherein the first identification code and the second identification code respectively comprise a set of extended display identification data (EDID).

10. The controlling method of claim 8, further comprising the step of:
when the output state shows that the first identification code or the second identification code is not being outputted from the identification output terminal, making the multiplexer to be switched between the first identification input terminal and the second identification terminal.

11. The controlling method of claim 8, further comprising the step of:
when the output state shows that the identification output terminal stops outputting the first identification code or the second identification code, making the multiplexer to be switched between the first identification input terminal and the second identification terminal after a confirming duration.

12. The controlling method of claim 8, further comprising the step of:
if the output state shows that the identification output terminal does not output the first identification code or the second identification code again in a confirming duration after the identification output terminal stops outputting the first identification code or the second identification code, making the multiplexer to be switched between the first identification input terminal and the second identification input terminal.

13. The controlling method of claim 8, further comprising the step of:
when the output state shows that the first identification code or the second identification code is not being outputted from the identification output terminal, alternatively detecting whether the first video signal input terminal or the second video signal input terminal receives any video signal.

14. The controlling method of claim 13, further comprising the steps of:
when whether the first video signal input terminal receives any video signal is being detected, controlling the multiplexer to be switched to the first identification input terminal; and
when whether the second video signal input terminal receives any video signal is being detected, controlling the multiplexer to be switched to the second identification input terminal.

15. A display apparatus, comprising:
a connecter having a plurality of pins for connecting to a display card outside the display apparatus;
a first video signal input terminal connecting to one of the pins;
a second video signal input terminal connecting to one of the pins;
a multiplexer comprising:
a first input terminal for receiving a first code corresponding to the first video signal input terminal; and
a second input terminal for receiving a second code corresponding to the second video signal input terminal; and
an output terminal for selectively outputting one of the first code and the second code to one of the pins; and
a controlling module, wherein when one of the first code and the second code is outputted from the output terminal, the controlling module makes the multiplexer stopping switching between the first input terminal and the second input terminal.

16. The display apparatus of claim 15, wherein the first code and the second code respectively comprises a set of extended display identification data (EDID).

17. The display apparatus of claim 15, wherein when the first code is outputted from the output terminal, the controlling module enables the multiplexer keep outputting from the first input terminal.

18. The display apparatus of claim 17, wherein the display card sends a first video single to the display apparatus through the first video signal input terminal.

19. The display apparatus of claim 15, when none of the first code and the second code is outputted from the output terminal, the controlling module makes the multiplexer switching between the first input terminal and the second input terminal.
